(19) United States
(12) Patent Application Publication
(10) Pub. No.: US 2004/0046384 A1
(43) Pub. Date: Mar. 11, 2004

(54) Random movement enhancing accessory for an automatic pool cleaner

(76) Inventor: Kenneth Lewis Hawksworth, Boksburg (ZA)

Correspondence Address: AKERMAN SENTERFITT, P.O. BOX 3188, WEST PALM BEACH, FL, 33402-3188, US

(21) Appl. No.: 10/451,575

(22) PCT Filed: Dec. 20, 2001
(86) PCT No.: PCT/ZA01/00210

(30) Foreign Application Priority Data
Dec. 21, 2000 (ZA) 20007733

(51) Int. Cl. A47L 9/24; F16L 27/00

(52) U.S. Cl. 285/7; 285/272

(57) ABSTRACT

A connector tube (7) is provided for installation in a suction hose of an automatic pool cleaning assembly, the connector tube comprising a central portion (21) of substantially rigid tube having at one end a first terminal portion (22) with its axis extending at an incline to that of the straight central portion, and at the other end a second terminal portion (23) having its axis likewise extending at an incline to the axis of the straight central portion. In end view taken along the axis of the central portion, the axis of the first terminal portion diverges from the axis of the second terminal portion to provide asymmetric connector tube.

### FIELD OF THE INVENTION

This invention relates to a random movement enhancing accessory for use in combination with an automatic swimming pool cleaner of the general type designed to move in a substantially random manner over the floor-and-walls of a swimming pool in order to clean same. More particularly, the invention is concerned with an accessory that enhances the randomness of the movement of the swimming pool cleaner over the surface to be cleaned, in particular, by countering the general tendency of such cleaners to follow general broad patterns that can tend to leave out certain areas of the pool surface.

Whilst the following description will be directed primarily at swimming pool cleaners, it will be understood that the invention is intended to apply in its scope to automatic pool cleaners used to clean any other pool of liquid.

### BACKGROUND TO THE INVENTION

There is a wide variety of different automatic swimming pool cleaners in use at the present time. Most of them are intended, and indeed designed, to move freely and randomly over the floor and wall surface of a pool in order to clean the entire surface area although there have been some designs in which a steering mechanism has been included with a view to modifying the uncontrolled random movement in order to make it more effective.

Nevertheless, for the most part, existing pool cleaners do not cover the entire surface area and patches, amounting quite commonly up to 30% of the surface area, are not covered by the pool cleaner during its supposedly “random” movement as a result of the fact that general patterns of movement tend to develop.

Numerous different reasons have been put forward to explain this failure. These include the fact that many pool cleaners become trapped against some or other formation in a swimming pool; the hose characteristics vary quite significantly and indeed hose sections can take on a particular crooked configuration in consequence of temperature fluctuations and physical forces that have been applied to the individual hose sections; the effective length of the hose may be incorrect and the hose may be too long or too short; and each different design of swimming pool and the location of the point of connection of the suction hose to the filtration assembly inhibits the swimming pool cleaner to a different extent and in different ways from reaching all regions of the surface.

A common partial cure that is recommended is to take the hose out of the pool; stretch it out in a straight line; and leave it in the sun for a time sufficient to enable it to totally relieve stresses in the plastic material from which it is made. Thereafter the hose should be cooled rapidly in the straight condition. This sometimes has a beneficial effect but by no means overcomes certain limitations that are inherent in some swimming pool installations and it also does not prevent the problem from recurring.

### OBJECT OF THE INVENTION

It is an object of this invention to provide an accessory that is aimed at diminishing the difficulty described above and in consequence enhancing the randomness with which many different types of automatic swimming pool cleaners moved over the surface to be cleaned.

### SUMMARY OF THE INVENTION

In accordance with this invention there is provided an accessory in the form of a connector tube for installation in a suction hose assembly, the connector tube comprising a central portion of substantially rigid tube having a generally longitudinally extending axis associated therewith, a first terminal portion at one end of the central portion and having its axis extending at an incline to the longitudinally extending axis associated with the central portion so that the axes of the first terminal portion and the central portion lie in a first plane, and a second terminal portion having an axis at the other end of the central portion, the connector tube being characterized in that the axis of the second terminal portion and the longitudinally extending axis associated with the central portion lie in a second plane that diverges relative to the first plane from the longitudinally extending axis associated central portion so that, in end view, the axis of the first terminal portion diverges from the axis of the second terminal portion.

Further features of the invention provide for the central portion to be a short straight portion; for the central portion and each of the two terminal portions to have approximately the same length, conveniently of the order about 20 to about 50 mm; for the one terminal portion to terminate in a spigot or socket formation for connection to a socket or spigot of a conventional suction hose assembly whilst the second terminal portion may either terminate in the other of such a socket or spigot for connection to a spigot or socket of an automatic pool cleaner head or be integral with a part, generally a rotatable part, of an automatic pool cleaner head; for the axis of the first terminal portion to make an angle with the longitudinally extending axis of the central portion of from about 5 to about 30 degrees, preferably from about 8 to about 20 degrees, and most preferably about 12 degrees; for the axis of the second terminal portion to make an angle with the longitudinally extending axis of the central portion of from about 10 to about 60 degrees, preferably from about 20 to about 40 degrees, and most preferably about 28 degrees; and for the first plane to make an angle of between 5 and 90 degrees with the second plane, preferably between about 60 and about 75 degrees and most preferably about 68 degrees.

Whilst it is presently intended that the connector tube will generally be made as a single part it is within the scope of this invention that it be made in two parts that may be attached to each other to form a composite connector tube as defined above. In such an instance the two parts could be adapted to be connected together with the said first and second planes diverging at an angle that can be selected either within a range or from a predetermined series of pre-set angles.

Preferably, the connector tube of the invention is included in a suction hose assembly in which a tubular assembly that serves to rotate one part of the suction hose relative to another part of the suction hose from time to time when suction is applied and released is connected between the ends of two contiguous lengths of suction hose. The tubular assembly is preferably located towards the end of the suction hose remote from the suction head, preferably where movement of the hose is minimal and accordingly generally near the point where the hose is connected to a suction inlet. The connecting tube is preferably installed between the suction head and the suction hose with said first terminal portion being connected to the hose and said second terminal portion being connected to the suction head.

A tubular assembly for connection to, or for inclusion in, a pool cleaner suction hose assembly as indicated above may comprise first and second tubular members, generally coaxial with each other and being freely relatively rotatable about a common axis in an inoperative condition, and means for inhibiting relative rotation of the members in the operative condition with suction applied to the interior thereof.

Other features of the tubular assembly will become apparent from the following description.

In order that the invention may be more fully understood one embodiment thereof will now be described with reference to the accompanying drawings.

### BRIEF DESCRIPTION OF THE DRAWINGS

In the drawings:

FIG. 1 is a plan view of a swimming pool employing an automatic pool cleaner fitted with the accessory of the invention and a tubular assembly of the type indicated above;

FIG. 2 is a partly sectioned elevation of a tubular assembly included in the preferred automated pool cleaner assembly including the connector tube of the invention;

FIG. 3 is an elevation of an automatic pool cleaner head fitted with a connector tube according to the invention;

FIG. 4 is an elevation of the connector tube alone taken in the direction indicated by line IV-IV in FIG. 6;

FIG. 5 is an elevation of the connector tube alone taken in the direction indicated by line V-V in FIG. 6;

FIG. 6 is an end view of the connector tube showing the angular offset between the axes of the two terminal portions thereof; and,

FIG. 7 is a sectional detail illustrating a combination spigot and socket provided on the second terminal portion.

### DETAILED DESCRIPTION WITH REFERENCE TO THE DRAWINGS

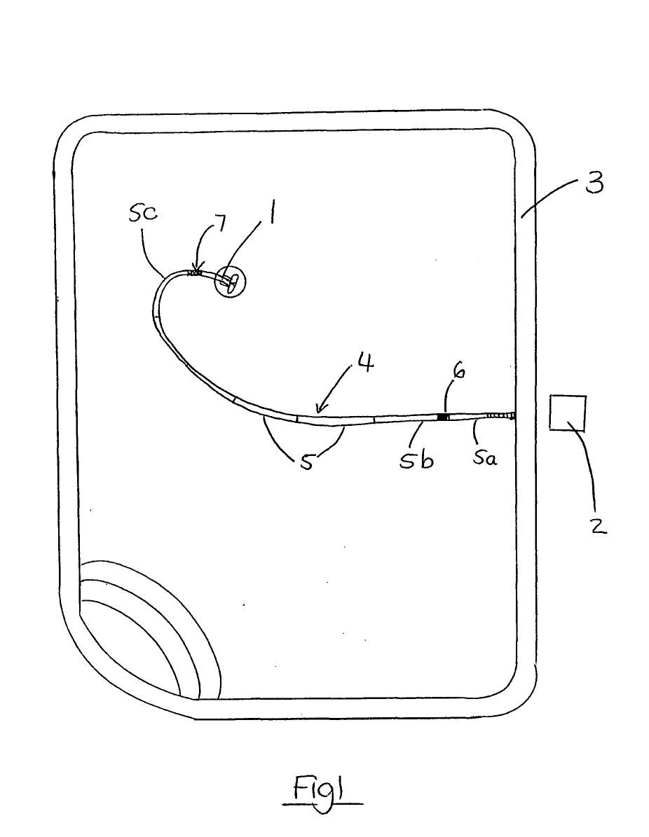

In this embodiment of the invention the connector tube is used in combination with a tubular assembly in a swimming pool cleaner assembly that is illustrated generally in FIG. 1. In this assembly an automatic pool cleaner suction head (1) is connected to the suction side of a filtration pump (not shown) usually by way of an inlet in a weir (2) positioned at the side of a swimming pool (3) by way of a suction hose generally indicated by numeral (4). The suction hose is made up of a series of contiguous lengths (5) of suction hose whereof each length has a spigot connector at one end and a socket connector at the opposite end. This arrangement enables a series of lengths to be connected together to provide a hose of the required overall length. Typically the hose will be of the type which has a helically extending rib on the outside thereof.

A tubular assembly generally indicated by numeral (6) is installed between the spigot of one length of suction hose and the socket on the next contiguous length of suction hose. This is preferably effected at a position removed from the suction head (1) and, in the illustrated situation, between the hose length (5a) connected to the weir and the next adjacent hose length (5b). In the event that an in-line leaf trap is included in the hose, this should be located between the tubular assembly and the suction inlet at the end of the suction hose remote from the pool cleaner head.

The connector tube of the invention and which is generally indicated by numeral (7) is connected between the suction head (1) and the hose length (5c) furthest from the weir.

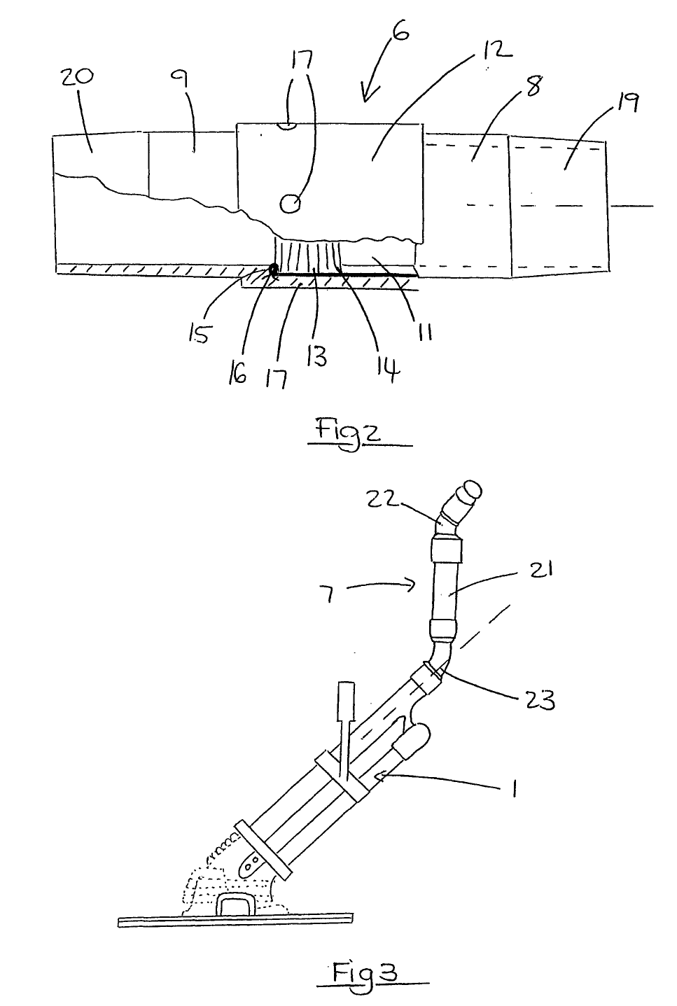

Referring now more particularly to FIG. 2, the tubular assembly comprises two substantially coaxial tubular plastics members (8) and (9). The first tubular member (8) has its one end region (11) received in an enlarged skirt end (12) of the second tubular member (9). The end region (11) of the first tubular member has a ridge (13) in its outer surface which co-operates within an internally directed ridge (14) formed on the inside of the second tubular member (9) so that the first tubular member is held captive relative to the second tubular member but is freely rotatable relative to the second tubular member about the common axis.

The second tubular member has a shoulder (15) at the inner end of the enlarged skirt end (12) into which the end region (11) of the first tubular member extends and the exposed surface of the shoulder is defined by a sealing ring (16) that is in line with the periphery of the inner end of the first tubular member. The sealing ring is thus coaxial with the two tubular members and is adapted to cooperate with the periphery of the inner end of the first tubular member to form a seal when suction is applied to the interior of the assembly.

A plurality of holes (17) is provided through the wall of the enlarged end (12) adjacent the sealing ring so that water can enter through these holes and flush the sealing ring each time suction is applied or released. Furthermore, these holes avoid the creation of a flow of water in through the rather narrow space between the inner surface of the enlarged end of the second tubular member and the adjacent outer surface of the inner end of the first tubular member and avoids dirt being drawn into the rather small space between these two surfaces. It will be understood that the skirt serves as a guide and a retainer for the first tubular member.

The one tubular member (8) has the outer surface at its free end formed into a conical spigot (19) complementary to a socket on a hose length and the end of the other tubular member may be formed into another spigot (20) or alternatively a socket similarly complementary to the conical spigots and sockets on the ends of suction hose lengths. Two spigots are used presently in order to facilitate initial production but ultimately a spigot and socket will be employed as this enables the assembly to be easily fitted into a suction hose at a joint between two hose lengths.

This arrangement is such that the one tubular member can rotate freely relative to the other tubular member when the assembly is inoperative. When, however, the assembly is operative, and a suction is applied to the interior thereof, the suction causes the periphery of the inner end of the first tubular member to move into engagement with the sealing ring and this has the effect of inhibiting the free rotation. A frictional braking force is thus generated either preventing or otherwise inhibiting relative rotation of these two tubular members.

Accordingly, after each time the swimming pool filter is turned off, the adjacent lengths of suction hose can rotate freely relative to each other which they generally do and cause the relative angular positions of the two lengths of hose connected by the tubular assembly to change. This causes the pool cleaner head to adopt a different path of movement the next time the swimming pool filter is turned on and suction is applied to the hose. This feature, when used in combination with the connector tube described below, is particularly advantageous as will become apparent from the following.

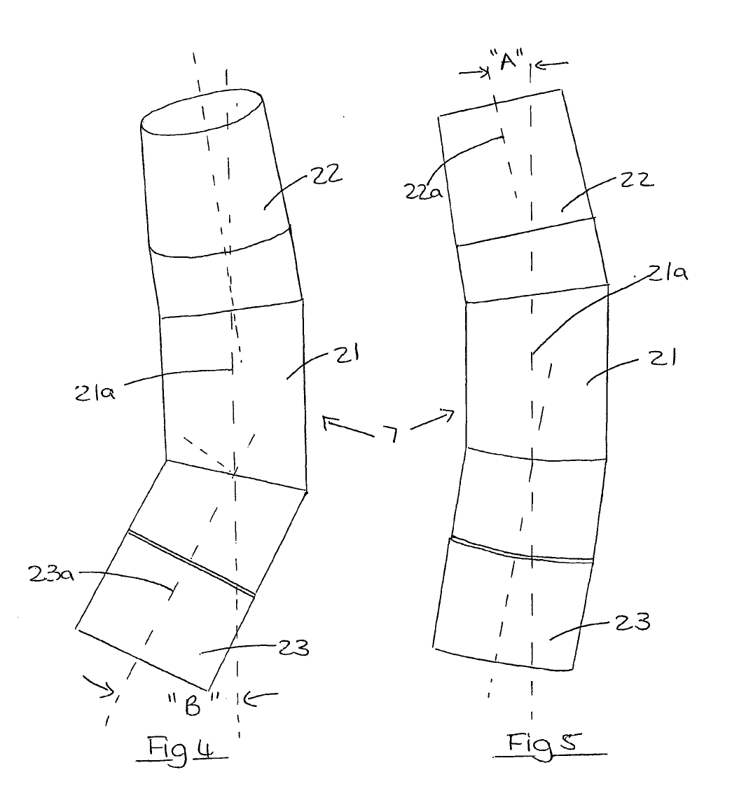

Turning now to the connector tube of the invention, and referring more particularly to FIGS. 3 to 6 of the drawings, the connector tube (7) has a central straight portion (21) and a first terminal portion (22) and a second terminal portion (23) at its two ends. The axes (22a and 23a) of the terminal portions each extend at an oblique angle to that of the axis (21a) of the central portion as indicated by angles “A” and “B” in FIGS. 5 and 4 respectively. These angles are, in this embodiment of the invention, about 12 and 28 degrees respectively. The first terminal portion (22) ends in a complementary spigot whilst the second terminal portion (23) ends in a combination spigot and socket that is illustrated in FIG. 7. The combination spigot and socket, has an inner tapered surface (25) compatible with certain types of suction heads of automatic swimming pool cleaners and an outer tapered surface (26) that is compatible with certain other types of suction heads.

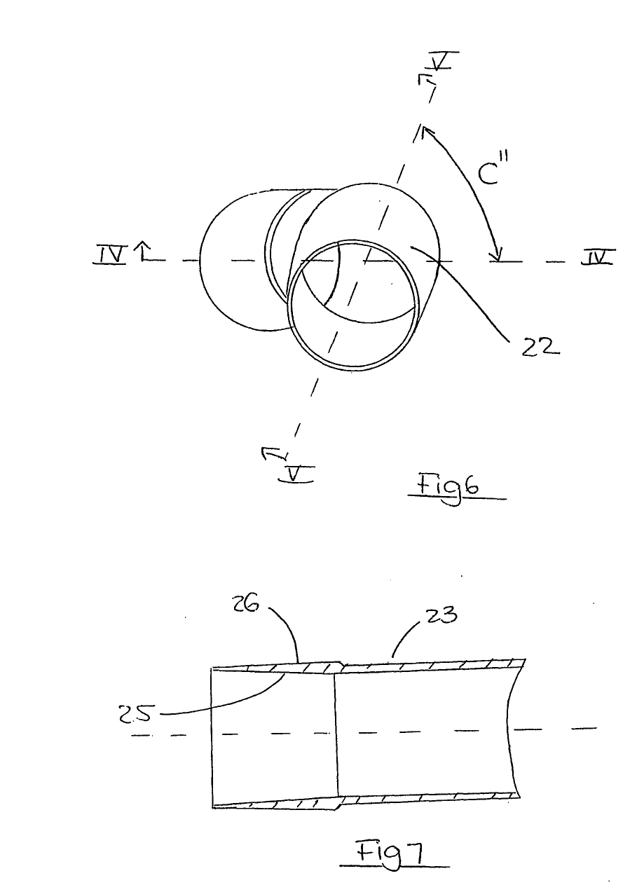

The axes of the two terminal portions are not coplanar. For ease of explanation line V-V in FIG. 6 can be considered to be a plane in which the axes of the central portion (21) and the first terminal portion (22) both lie (the real inclination between the two being indicated as angle “A” in FIG. 5) and line IV-IV can be considered to be a plane in which the axes of the central portion and the second terminal portion (23) both lie (the real inclination between the two being indicated as angle “B” in FIG. 4). These two planes make an angle “C” with each other as shown clearly in FIG. 6 and this angle is, in this embodiment of the invention, about 68 degrees.

The connector tube normally has the second terminal portion attached directly to the pool cleaner head as shown in FIG. 3 and is attached to the usual rotatable spigot or socket associated with the suction head. The opposite end, that is to say the first terminal portion of the connector tube is attached to the suction hose.

It has been found that, in use, the connector tube is highly effective in assisting in steering the suction head in a random manner and, more particularly, out of difficult situations. This is believed to be due to the fact that the tubular assembly operates to vary the angular positions of the two hose lengths between which it is located each time the filtration plant is turned on and off and thus suction is applied and removed. In the case of a hose with a helical rib the contraction resulting from the application of suction each time it is applied causes rotation of the end of the hose attached to the connector tube, and, accordingly, rotation of the connector tube.

As a result of the asymmetric configuration of the connector tube this results in a different path being followed by the suction head. Each time the suction is removed the two tubular members become disengaged and can rotate freely as the hose relaxes from its contracted condition. The connector tube is thus not rotated at this stage but is only rotated once more when suction is next applied to the hose. A general progressive step by step rotation of the connector tube in one direction therefore results as the suction is applied and removed. The random movement of the suction head and the overall cleaning efficiency thereof is thus substantially enhanced.

It is to be noted that the particular angles “A”, “B” and “C” indicated above can be varied widely it being the most important feature of the invention that the connector tube is asymmetric so that in end view the two planes described above cause the axes of the terminal portions to diverge from the axis of the central portion.

The length of the central portion can be varied appreciably and indications are that different lengths of central portion may be more appropriate to certain types of automatic pool cleaners than others. It is envisaged, accordingly, that different connector tubes may be produced for each different type of automatic pool cleaner head and that the various angles indicated above as well as the length of the terminal and central portions may be chosen empirically for each type of head.

Furthermore, it is to be mentioned that the central portion of the connector tube need have no straight section whatsoever and could be a continuous curve joining the axes of the two terminal portions. In such a case the longitudinally extending axis of the central portion indicated above would be the axis passing through the centre of the length of the central portion in the longitudinal direction.

Clearly, many variations may be made to the embodiment of the invention described above without departing from the scope hereof. In particular, the tubular assembly could be omitted and the connector tube could be used on its own or in combination with any other accessory or performance enhancing items.

1. A connector tube (7) comprising a central portion (21) of substantially rigid tube having a generally longitudinally extending axis (21a) associated therewith, a first terminal portion (22) at one end of the central portion and having its axis (22a) extending at an incline to the longitudinally extending axis associated with the central portion so that the axes of the first terminal portion and the central portion lie in a first plane (V-V), and a second terminal portion (23) having an axis (23a) at the other end of the central portion, the connector tube being characterized in that the axis of the second terminal portion and the longitudinally extending axis associated with the central portion lie in a second plane (VI-VI) that diverges relative to the first plane from the longitudinally extending axis associated central portion so that, in end view, the axis of the first terminal portion diverges from the axis of the second terminal portion.

2. A connector tube as claimed in claim 1 In which the central portion and each of the two terminal portions have approximately the same length.

3. A connector tube as claimed in either one of claims 1 or 2 in which the one terminal portion terminates in a spigot or socket formation for connection to a socket or spigot of a conventional suction hose assembly whilst the second terminal portion may either terminate in the other of such a socket or spigot for connection to a spigot or socket of an automatic pool cleaner head or be integral with a part of the automatic pool cleaner head.

4. A connector tube as claimed in claim 3 in which the second terminal portion terminates in a combination spigot and socket having a tapered inner and a tapered outer surface for cooperation selectively with a cooperating socket or spigot respectively of an automatic pool cleaner, head.

5. A connector tube as claimed in any one of the preceding claims in which the axis of the first terminal portion makes an angle with the longitudinally extending axis of the central portion of from about 5 to about 30 degrees.

6. A connector tube as claimed in claim 5 in which the axis of the first terminal portion makes an angle with the longitudinally extending axis of the central portion of from about 8 to about 20 degrees.

7. A connector tube as claimed in any one of the preceding claims in which the axis of the second terminal portion makes an angle with the longitudinally extending axis of the central portion of from about 10 to about 60 degrees.

8. A connector tube as claimed in claim 7 in which the second terminal portion makes an angle with the longitudinally extending axis of the central portion of from about 20 to about 40 degrees.

9. A connector tube as claimed in any one of the preceding claims in which the said first plane makes an angle of between 5 and 90 degrees with the said second plane.

10. A connector tube as claimed in claim 9 in which the said first plane makes an angle of between about 60 and about 75 degrees with the said second plane.
